(19) United States
(12) Patent Application Publication
(10) Pub. No.: US 2024/0272594 A1
(43) Pub. Date: Aug. 15, 2024

(54) CONTROL DEVICE, CONTROL METHOD, AND RECORDING MEDIUM

(71) Applicant: FUJI ELECTRIC CO., LTD., Kanagawa (JP)

(72) Inventor: Yoshio TANGE, Tokyo (JP)

(21) Appl. No.: 18/616,931

(22) Filed: Mar. 26, 2024

Related U.S. Application Data
(63) Continuation of application No. PCT/JP2023/004834, filed on Feb. 13, 2023.

(30) Foreign Application Priority Data
Apr. 15, 2022 (JP) 2022-067612

(51) Int. Cl. G05B 13/04; G05B 15/02

(52) U.S. Cl. CPC G05B 13/048; G05B 13/042; G05B 15/02

(57) ABSTRACT

A control device is configured to calculate a difference between a target value and a current value of a controlled variable for a control target; store predicted values obtained by forgetting a predicted value of the controlled variable that is predicted in a past time by a plant response function; calculate a corrected difference from the difference and a predicted value of the controlled variable after a predetermined lookahead length elapses, based on the predicted values; calculate a change in a value of a manipulated variable based on the corrected difference and a predetermined control gain; calculate a new value of the manipulated variable by adding the change of the value of the manipulated variable to the value of the manipulated variable; and output the new value of the manipulated variable to the control target so that a value of the controlled variable is caused to track the target value.

### CROSS-REFERENCE TO RELATED APPLICATIONS

This application is a continuation application of International Application No. PCT/JP2023/004834 filed on Feb. 13, 2023, and designating the U.S., which is based upon and claims priority to Japanese Patent Application No. 2022-067612, filed on Apr. 15, 2022, the entire contents of which are incorporated herein by reference.

### BACKGROUND

### 1. Technical Field

The present disclosure relates to a control device, a control method, and a recording medium.

### 2. Description of the Related Art

Control devices, such as a temperature adjustment control device, a programmable logic controller (PLC), and a distributed control system (DCS), control devices implemented on a personal computer and an embedded control device, and the like are widely used in industry.

Additionally, as a control method for causing a controlled variable of a control target to track a target value, various control methods such as proportional-integral-differential (PID) control, model predictive control, internal model control, linear-quadratic-Gaussian (LOG) control, H2 control, H∞ control, and the like are known.

The model predictive control is a method of obtaining a desired response by sequentially performing optimization calculation using a state space model or a future time response model of a control target, and is widely used in industry (for example, Non-Patent Document 1). For example, as an industrial application of standard model predictive control that executes a numerical optimization algorithm online, an application to air conditioning system control and the like is known (for example, Patent Document 1).

Additionally, a control device that determines a new value of a manipulated variable based on a corrected target deviation that is a difference between a target value and a predicted value of a controlled variable corresponding to a change in past values of the manipulated variable up to the present is proposed (for example, Patent Document 2 and Patent Document 3).

Further, a control device that determines a value of a manipulated variable by a future prediction based on a model of a control target plant and learns, online, a model parameter included in a plant response function representing the model is proposed (for example, Patent Document 4).

### RELATED ART DOCUMENT

### Patent Document

Patent Document 1: Japanese Laid-Open Patent Application Publication No. 2015-108499
Patent Document 2: International Publication Pamphlet No. WO 2016/092872
Patent Document 3: Japanese Laid-Open Patent Application Publication No. 2020-21411
Patent Document 4: Japanese Patent No. 6901037

### Non-Patent Document

Non-Patent Document 1: Jan M. Maciejowski, “Model Predictive Control—optimal control with constraints”, Tokyo Denki University Press, 2005

### SUMMARY

According to one embodiment of the present disclosure, A control device includes a processor; and a memory storing program instructions that cause the processor to calculate a target deviation that is a difference between a target value and a current value of a controlled variable for a control target at a current time; store forgetting prediction time series data including predicted values obtained by forgetting a predicted value of the controlled variable that is predicted in a past time by a plant response function representing a plant response model of the control target; calculate a corrected target deviation from the target deviation and a predicted value of the controlled variable after a predetermined lookahead length elapses, based on the forgetting prediction time series data; calculate a change in a value of a manipulated variable based on the corrected target deviation and a predetermined control gain; calculate a new value of the manipulated variable by adding the change of the value of the manipulated variable to the value of the manipulated variable; and output the new value of the manipulated variable to the control target so that a value of the controlled variable of the control target is caused to track the target value.

### BRIEF DESCRIPTION OF THE DRAWINGS

FIG. 1 is a diagram illustrating an example of a hardware configuration of a control device according to a first embodiment;

FIG. 2 is a diagram illustrating an example of a functional configuration of the control device according to the first embodiment;

FIG. 3 is a diagram for explaining an example of an operation of a corrected target deviation calculating unit;

FIG. 4 is a diagram for explaining an example of updating of a forgetting prediction time series storage unit;

FIG. 5 is a diagram for explaining an example of an operation of a manipulated variable change calculating unit;

FIG. 6 is a diagram illustrating an example of a functional configuration of a control device according to a second embodiment;

FIG. 7 is graphs representing a step response of a control target plant in the first embodiment;

FIG. 8 is graphs representing a step response of a plant response model in the first embodiment;

FIG. 9 is graphs representing a control response in a case where forgetting is not performed in the first embodiment;

FIG. 10 is graphs representing a control response in a case where the forgetting is performed in the first embodiment;

FIG. 11 is graphs representing a step response of a control target plant and a plant response model in the second embodiment;

FIG. 12 is graphs representing a target value and disturbance in the second embodiment;

FIG. 13 is graphs representing a control response in a case where the forgetting is not performed in the second embodiment; and

FIG. 14 is graphs representing a control response in a case where the forgetting is performed in the second embodiment.

### DETAILED DESCRIPTION

A model predictive control performs precise control by a future prediction based on a model of a control target, and thus it is said that high control performance can be achieved in comparison with control having no model of a control target such as PID control, in general. On the other hand, when a model used for the model predictive control is largely different from a control target or when an unknown disturbance that is not included in an input-output relationship assumed in advance acts, a future prediction may be largely different from the reality, and as a result, there is a problem that the control performance may deteriorate.

A model predictive control in the related art is based on the premise that a model accurately represents a control target, and therefore, it is difficult to cope with the above-described problem.

It is desirable to provide a technique for suppressing a decrease in control performance in model predictive control.

According to at least one embodiment of the present disclosure, a technique for suppressing a decrease in control performance in model predictive control is provided.

In the following, embodiments of the present invention will be described. Hereinafter, a control device 10, which calculates a manipulated variable for causing a controlled variable to track a target value by model predictive control when the target value is given for an arbitrary plant as a control target, will be described. In this case, by introducing what is called a forgetting factor, a model of the control target plant (hereinafter, also referred to as a plant response model) causes predicted values of the controlled variable that are predicted in the past to be asymptotically forgotten (i.e., the predicted values in the past are gradually forgotten as the predicted values become older). This suppresses an adverse effect on the control due to the future prediction error of the plant response model, thereby suppressing a decrease in control performance due to the future prediction error.

Here, the control device 10 described below may be implemented by, for example, a personal computer (PC), a general-purpose server, or the like, or may be implemented by an edge device (PLC, DCS, or the like) having a poor calculation resource in comparison with the PC or the general-purpose server.

### First Embodiment

A first embodiment will be described below.

The control device 10 according to the present embodiment calculates a manipulated variable u for a control target plant 20 based on a selected target value r, a controlled variable y indicating a state and the like of the control target plant 20, a plant response model of the control target plant 20, and the like. Then, the control device 10 according to the present embodiment obtains a controlled variable y of the control target plant 20 corresponding to the manipulated variable u, and calculates a next value of the manipulated variable u based on the target value r, the controlled variable y, the plant response model, and the like. As described above, the control device 10 according to the present embodiment repeatedly performs the calculating of the manipulated variable u for causing the controlled variable y to track the target value r during an online operation (that is, during the control of the control target plant 20).

Here, examples of the controlled variable y include the temperature of the control target plant 20, and examples of the target value r include a set temperature. However, the controlled variable y and the target value r are not limited to the temperature and the set temperature, and any controlled variable in the control target plant 20 and a target value serving as a target of the controlled variable can be used. Additionally, examples of the manipulated variable u include a duty ratio of pulse width modulation (PWM) control to an electric heater, a ratio of conduction time per unit time, a steam valve opening degree, and a cold water valve opening degree. However, the manipulated variable u is not limited thereto, and any manipulated variable in the control target plant 20 can be used.

### <Hardware Configuration of Control Device 10>

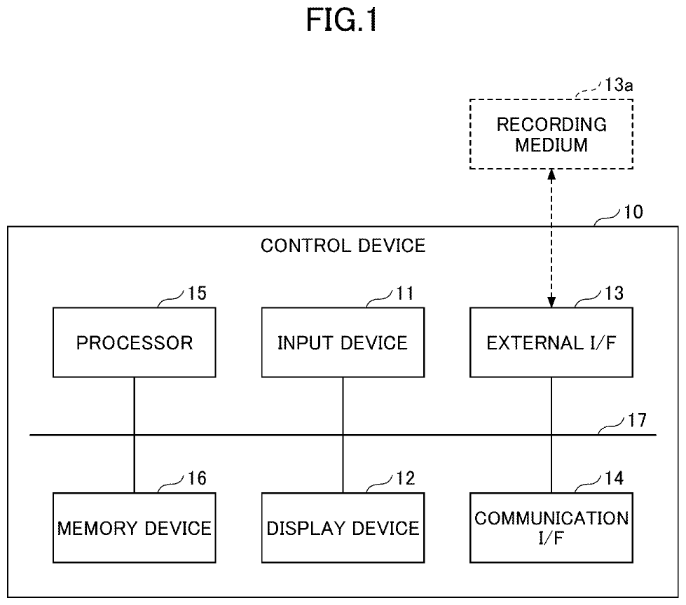

First, a hardware configuration of the control device 10 according to the present embodiment will be described with reference to FIG. 1. FIG. 1 is a diagram illustrating an example of the hardware configuration of the control device 10 according to the first embodiment.

As illustrated in FIG. 1, the control device 10 according to the present embodiment includes an input device 11, a display device 12, an external interface (I/F) 13, a communication I/F 14, a processor 15, and a memory device 16. These hardware components are communicably connected to each other via a bus 17.

Examples of the input device 11 include a keyboard, a mouse, a touch panel, various physical buttons, and the like. The display device 12 is, for example, a display, a display panel, or the like. Here, the control device 10 need not include the input device 11, the display device 12, or both, for example.

The external I/F 13 is an interface with an external device such as a recording medium 13a. Examples of the recording medium 13a include a compact disc (CD), a digital versatile disk (DVD), a secure digital (SD) memory card, a universal serial bus (USB) memory card, and the like.

The communication I/F 14 is an interface for connecting the control device 10 to a communication network. Examples of the processor 15 include various arithmetic devices, such as a central processing unit (CPU) and a micro-processing unit (MPU). Examples of the memory device 16 include various storage devices, such as a solid state drive (SSD), a random access memory (RAM), a read only memory (ROM), and a flash memory.

Here, the hardware configuration illustrated in FIG. 1 is an example, and the control device 10 may have another hardware configuration. For example, the control device 10 may include multiple processors 15 and multiple memory devices 16, and may include various hardware components other than the hardware components illustrated in the drawing.

### <Functional Configuration of Control Device 10>

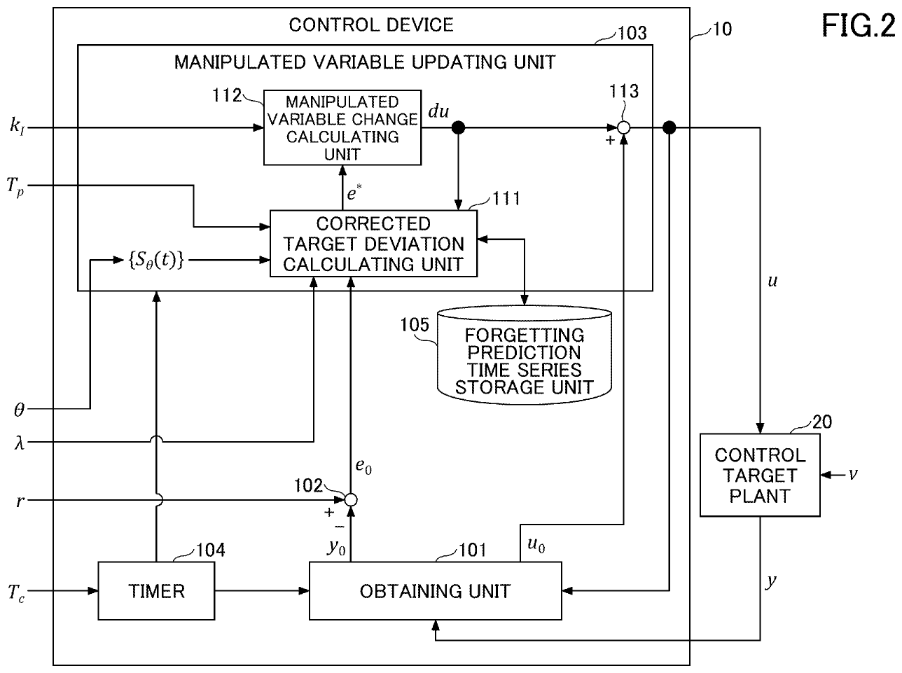

Next, a functional configuration of the control device 10 according to the present embodiment will be described with reference to FIG. 2. FIG. 2 is a diagram illustrating an example of the functional configuration of the control device 10 according to the first embodiment.

As illustrated in FIG. 2, the control device 10 according to the present embodiment includes an obtaining unit 101, a differentiator 102, a manipulated variable updating unit 103, and a timer 104. These are implemented by, for example, the processor 15 or the like executing one or more programs installed in the control device 10. Additionally, the control device 10 according to the present embodiment includes a forgetting prediction time series storage unit 105. The forgetting prediction time series storage unit 105 is implemented by, for example, the memory device 16 included in the control device 10.

The obtaining unit 101 obtains (observes) the controlled variable y of the control target plant 20 in each control cycle T_{c}. Then, the obtaining unit 101 outputs a latest value of the obtained controlled variable y as a current value y₀ of the controlled variable. Here, the controlled variable y of the control target plant 20 is determined according to the manipulated variable u and a disturbance v. Examples of the disturbance v include a decrease or an increase in the outside air temperature when the controlled variable y is the temperature, and the like.

Additionally, the obtaining unit 101 obtains (observes) the manipulated variable u output from the manipulated variable updating unit 103 in each control cycle T_{c}, and outputs a latest value of the obtained manipulated variable u as a current value u₀ of the manipulated variable.

The differentiator 102 outputs a difference (deviation) between the target value r and the current value y₀ of the controlled variable as a target deviation e₀. The target deviation e₀(t) at time t is calculated by e₀(t)=r(t)−y₀(t). Here, in the present embodiment, the target value is constant, that is, r(t) is a constant.

The manipulated variable updating unit 103 calculates the manipulated variable u for the control target plant 20 in each control cycle T_{c}. Here, the manipulated variable updating unit 103 includes a corrected target deviation calculating unit 111, a manipulated variable change calculating unit 112, and an adder 113.

The corrected target deviation calculating unit 111 calculates a corrected target deviation e*(t) that is obtained by correcting the target deviation e₀(t) based on the plant response function {S_{θ}(t)}, the target deviation e₀(t), a manipulated variable change time series data {du(t)}, which is time series data of changes du of past values of the manipulated variable u, a lookahead length Tₚ, and a forgetting factor λ. At this time, the corrected target deviation calculating unit 111 calculates and updates prediction time series data (time series data of predicted values of the controlled variable y up to a certain time in the future in consideration of the forgetting of the past predicted values) stored in the forgetting prediction time series storage unit 105. Here, the plant response function {S_{θ}(t)} is a function including a model parameter θ, and is a plant response model of the control target plant 20. As the plant response function S_{θ} (·), for example, a function that outputs a step response of the control target plant 20 in response to the time t being input can be used. Here, a method of calculating the corrected target deviation e*(t) will be described in detail later.

The manipulated variable change calculating unit 112 calculates a manipulated variable change du(t) based on the corrected target deviation e*(t) and a control gain k_{I}. The manipulated variable change calculating unit 112 calculates and outputs the manipulated variable change du(t) in the order of du (t−3T_{c}), du (t−2T_{c}), and du (t−T_{c}), for example. Here, the manipulated variable change du is an amount by which the manipulated variable u changes in each control cycle T_{c}.

The adder 113 adds the current value u₀ of the manipulated variable output from the obtaining unit 101 and the manipulated variable change du output from the manipulated variable change calculating unit 112 to calculate a new value of the manipulated variable u. Then, the adder 113 outputs the new value of the manipulated variable u to the control target plant 20. The new value of the manipulated variable u is calculated by u(t)=u₀+du(t)=u(t−T_{c})+du(t).

The timer 104 causes the obtaining unit 101 and the manipulated variable updating unit 103 to operate in each control cycle T_{c}. That is, the timer 104 operates as an operation trigger of the obtaining unit 101 and the manipulated variable updating unit 103 in each control cycle T_{c}. The control cycle T_{c} is a cycle for controlling the control target plant 20, and the value thereof is set in advance.

The forgetting prediction time series storage unit 105 stores the prediction time series data (the time series data of the predicted values of the controlled variable y up to a certain time in the future in consideration of the forgetting of the past predicted value) calculated by the corrected target deviation calculating unit 111.

With the functional configuration described above, the control device 10 according to the present embodiment can control the control target plant 20 by sequentially repeating the obtaining of the controlled variable y and the manipulated variable u by the obtaining unit 101 and the calculating of the new value of the manipulated variable u by the manipulated variable updating unit 103 in each control cycle T_{c}.

### <Operation of Corrected Target Deviation Calculating Unit 111>

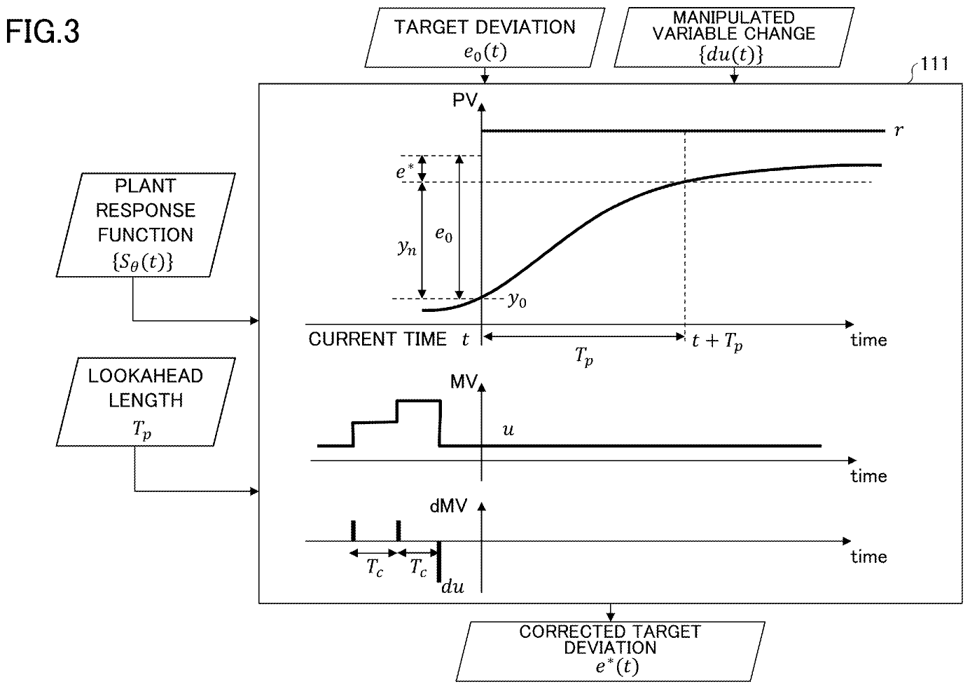

Next, an operation of the corrected target deviation calculating unit 111 will be described with reference to FIG. 3. FIG. 3 is a diagram for explaining an example of the operation of the corrected target deviation calculating unit 111.

As illustrated in FIG. 3, the corrected target deviation calculating unit 111 calculates, in response to the plant response function {S_{θ}(t)}, the target deviation e₀(t), the manipulated variable change time series data {du(t)}, and the lookahead length Tₚ being input, a predicted value, predicted based on the past manipulated variable change in consideration of the forgetting of the past predicted value, to which the controlled variable is changed after the lookahead length Tₚ has elapsed from the current time t, as a lookahead response correction yₙ(t).

Then, the corrected target deviation calculating unit 111 outputs a corrected target deviation e*(t) obtained by correcting the target deviation e₀(t) by the lookahead response correction values yₙ(t). Here, the corrected target deviation e*(t) is calculated by e*(t)=r(t)−(y₀(t)+yₙ (t))=e₀(t)−yₙ(t).

Here, the lookahead response correction value yₙ(t) is calculated using the prediction time series data stored in the forgetting prediction time series storage unit 105. A specific example of the calculation method will be described below.

A predicted value of the controlled variable y at the time s that is predicted at the time t is defined as a generalized predicted value y_{n,c}(s|t), and is calculated by the following equation. Here, the generalized predicted value y_{n,c}(s|t) may be referred to as a forgetting predicted value.

$${y}_{n , C} ( s \vert t ) = {\sum }_{k = 0}^{M} {λ}^{k} {S}_{θ} ( s + {kT}_{c} ) du ( t - {kT}_{c} ) \qquad [ Equation 1 ]$$

Here, M is a length of a model (a model section) used for calculating the generalized predicted value. Additionally, λ is a forgetting factor and is a value that satisfies 0≤ λ≤1. Here, λ is preferably a value less than 1 and close to 1 (for example, λ=0.9, λ=0.99, or the like). At this time, it is assumed that the generalized predicted value y_{n,c}(s|t) from the time t−Δt to future time t+T_{b} is stored as the time series data in the forgetting prediction time series storage unit 105, when t is the current time. That is, it is assumed that y_{n,c}(t−Δt|t), y_{n,c}(t|t), y_{n,c}(t+Δt|t), . . . , y_{n,c}(t+T_{b}|t) are stored in the forgetting prediction time series storage unit 105. Here, T_{b} is a constant for determining the length (the time series length) of the generalized predicted values y_{n,c} stored in the forgetting prediction time series storage unit 105, and is expressed as T_{b}=N₁Δt (N₁ is a predetermined arbitrary positive integer). Additionally, Δt is a prediction time interval, and Δt=T_{c}.

When the generalized predicted value y_{n,c} is used, a lookahead response predicted value y_{n,A}(t), which is the predicted value of the controlled variable y at the lookahead time t+Tₚ that is predicted based on the manipulated variable change time series {du(t)}, is y_{n,A}(t)=y_{n,c}(t+Tₚ|t). Additionally, a free response predicted value y_{n,B}(t), which is the predicted value of the controlled variable y at the current time t that is predicted based on the manipulated variable change time series {du(t)}, is y_{n,B}(t)=y_{n,c}(t|t). By using the lookahead response predicted value y_{n,A}(t) and the free response predicted value y_{n,B}(t), the lookahead response correction value yₙ(t) can be calculated as yₙ (t)=y_{n,A}(t)−y_{n,B}(t).

Here, the forgetting prediction time series storage unit 105 is updated by the corrected target deviation calculating unit 111 each time a new value of the manipulated variable change du(t) is calculated by the manipulated variable change calculating unit 112. Therefore, by using the forgetting prediction time series storage unit 105, the corrected target deviation e*(t) can be calculated with a smaller amount of calculation and a smaller amount of memory in comparison with the case where the generalized predicted value y_{n,c} is recalculated each time. A specific example of a method of updating the forgetting prediction time series storage unit 105 will be described below.

The generalized predicted value y_{n,c}(t+mΔt|t) at mΔt after the time t that is predicted at the time t is expressed as follows.

$${y}_{n , C} ( t + m Δ t \vert t ) = {\sum }_{k = 0}^{M} {λ}^{k} {S}_{θ} ( m Δ t + k Δ t ) du ( t - k Δ t ) \qquad [ Equation 2 ]$$

Here, m=0, 1, . . . , N₁.

Additionally, the generalized predicted value y_{n,c}(t+Δt+mΔt|t+Δt) at mΔt after the time t+Δt that is predicted at the time t+Δt is expressed as follows.

$$\begin{matrix}{y}_{n , C} ( t + Δ t + m Δ t \vert t + Δ t ) = {\sum }_{k = 0}^{M} {λ}^{k} {S}_{θ} ( m Δ t + k Δ t ) du ( t + Δ t - k Δ t ) \\ = {S}_{θ} ( m Δ t ) du ( t + Δ t ) + {\sum }_{k = 1}^{M} {λ}^{k} {S}_{θ} ( m Δ t + k Δ t ) du ( t + Δ t - k Δ t ) \\ = {S}_{θ} ( m Δ t ) du ( t + Δ t ) + λ {\sum }_{k = 0}^{M} {λ}^{k} {S}_{θ} ( m Δ t + Δ t + k Δ t ) du ( t - k Δ t ) \\ = {S}_{θ} ( m Δ t ) du ( t + Δ t ) + λ \cdot {y}_{n , C} ( t + ( m + 1 ) Δ t \vert t )\end{matrix} \qquad [ Equation 3 ]$$

That is, the generalized predicted value y_{n,c}(t+Δt+mΔt|t+Δt) at mΔt after the time t+Δt that is predicted at the time t+Δt is y_{n,c}(t+Δt+mΔt|t+Δt)=S_{θ}(mΔt)du(t+Δt)+λ·y_{n,c}(t+(m+1) Δt|t). This indicates that y_{n,c}(t+Δt+mΔt|t+Δt) can be calculated as a value obtained by adding the effect of the manipulated variable change du(t+Δt) at the time t+Δt to a value obtained by multiplying the generalized predicted value y_{n,c} at (m+1) Δt after the time t that is predicted at the time t by the forgetting factor A. Therefore, the forgetting prediction time series storage unit 105 at the time t+Δt can be updated by using the prediction time series data stored in the forgetting prediction time series storage unit 105 at the time t and the manipulated variable change du(t+Δt).

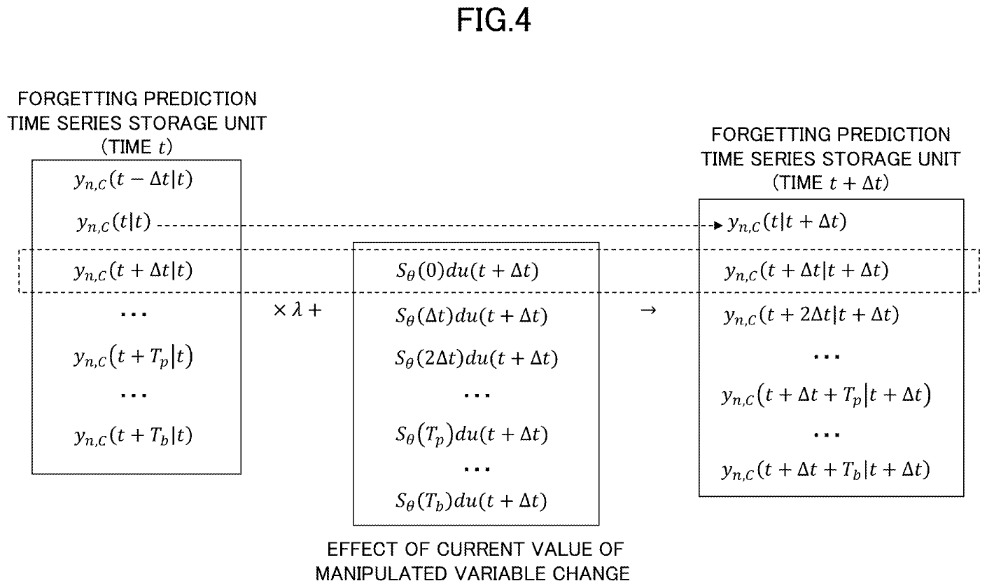

As an example, a case where the forgetting prediction time series storage unit 105 at the time t+Δt can be updated by using the prediction time series data stored in the forgetting prediction time series storage unit 105 at the time t and the manipulated variable change du(t+Δt) will be described with reference to FIG. 4. FIG. 4 is a diagram for explaining an example of updating the forgetting prediction time series storage unit 105. Here, the lookahead length Tₚ is expressed as Tₚ=N₂Δt (N₂ is a predetermined arbitrary positive integer satisfying N₂≤N₁).

The forgetting prediction time series storage unit 105 at the time t+Δt stores prediction time series data, which is y_{n,c} (t|t+Δt), y_{n,c}(t+Δt|t+Δt), y_{n,c}(t+2Δt|t+Δt), . . . , y_{n,c} (t+Δt+Tₚ|t+Δt), . . . , y_{n,c}(t+Δt+T_{b}|t+Δt). At this time, y_{n,c}(t|t+Δt) can be calculated as a value obtained by multiplying y_{n,c}(t|t) by the forgetting factor λ. Next, y_{n,c}(t+Δt|t+Δt) can be calculated as a value obtained by adding S_{θ}(0) du(t+Δt) to a value obtained by multiplying y_{n,c}(t+Δt|t) by the forgetting factor λ. In the following, similarly, with respect to m=1, 2, . . . , N₁−1, y_{n,c}(t+Δt+mΔt|t+Δt) can be calculated as a value obtained by adding S_{θ}(mΔt)du(t+Δt) to λ·y_{n,c}(t+(m+1) Δt|t). Here, y_{n,c}(t+Δt+T_{b}|t+Δt) is calculated according to the above Equation 1.

As described above, in the forgetting prediction time series storage unit 105, the predicted value at the time t is updated to the predicted value at the time t+Δt by adding the effect of the new manipulated variable change du(t+Δt) while forgetting the predicted value at the time t by the forgetting coefficient λ.

### <Operation of Manipulated Variable Change Calculating Unit 112>

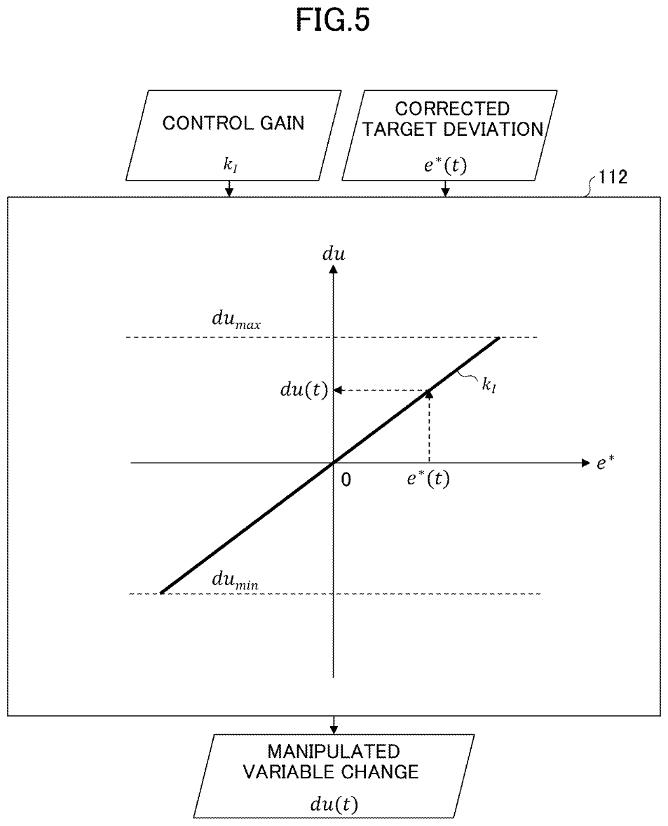

Next, an operation of the manipulated variable change calculating unit 112 will be described with reference to FIG. 5. FIG. 5 is a diagram for explaining an example of the operation of the manipulated variable change calculating unit 112.

As illustrated in FIG. 5, in response to the corrected target deviation e*(t) and the control gain k_{I} being input, the manipulated variable change calculating unit 112 outputs the manipulated variable change du(t) by multiplying the corrected target deviation e*(t) by the control gain k_{I}. That is, the manipulated variable change calculating unit 112 calculates the manipulated variable change du(t) by du(t)=k_{I}×e*(t).

However, when a result of multiplying the corrected target deviation e*(t) by the control gain k_{I} is greater than an upper limit value duₘₐₓ, the manipulated variable change calculating unit 112 sets duₘₐₓ as the manipulated variable change du(t). Similarly, when the result of multiplying the corrected target deviation e*(t) by the control gain k_{I} is less than a lower limit value duₘᵢₙ, the manipulated variable change calculating unit 112 sets duₘᵢₙ as the manipulated variable change du(t). This can provide a limiter for the upper and lower limit range. Here, the values duₘₐₓ and duₘᵢₙ may be set as needed so that the manipulated variable u after the current value u₀ of the manipulated variable and the manipulated variable du are added by the adder 113 does not deviate from a predetermined upper and lower limit range.

### Second Embodiment

A second embodiment will be described below. Here, in the second embodiment, the differences from the first embodiment will be described, and the description of substantially the same components as those in the first embodiment will be omitted.

The control device 10 according to the present embodiment repeatedly performs the calculating of the manipulated variable u for causing the controlled variable y to track the target value r and the estimating of the model parameter of the plant response model during an online operation. This can estimate a model parameter tracking a change over time, such as a seasonal variation, aged deterioration, and the like of the plant characteristic, after the start of the operation of the control target plant 20, for example.

### <Functional Configuration of Control Device 10>

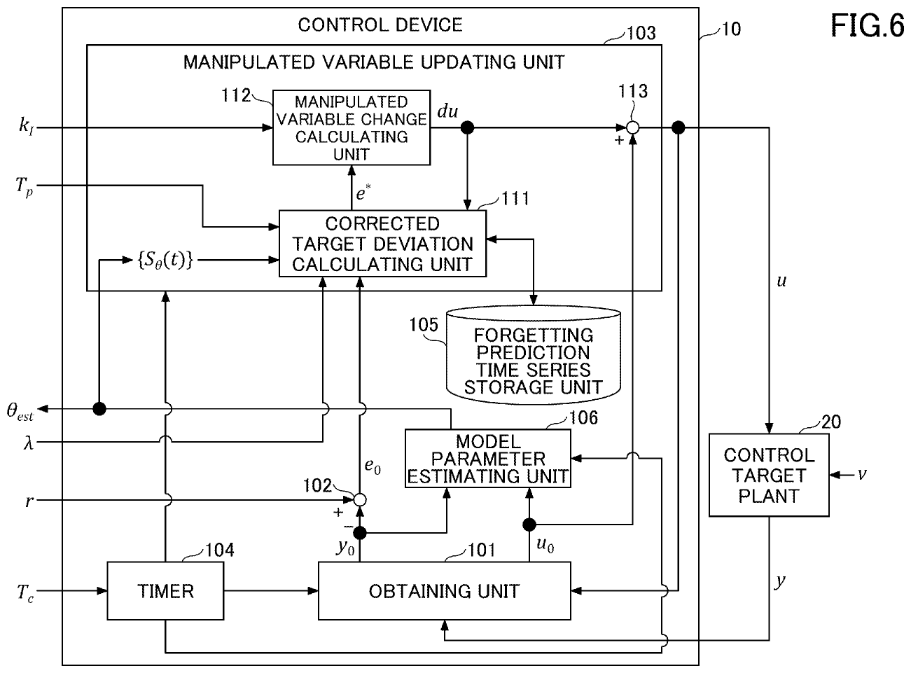

A functional configuration of the control device 10 according to the present embodiment will be described with reference to FIG. 6. FIG. 6 is a diagram illustrating an example of the functional configuration of the control device 10 according to the second embodiment.

As illustrated in FIG. 6, the control device 10 according to the present embodiment includes a model parameter estimating unit 106 in addition to the obtaining unit 101, the differentiator 102, the manipulated variable updating unit 103, the timer 104, and the forgetting prediction time series storage unit 105 described in the first embodiment. The model parameter estimating unit 106 is implemented by, for example, the processor 15 or the like executing one or more programs installed in the control device 10.

The model parameter estimating unit 106 receives the current value y₀(t) of the controlled variable and the current value u₀(t) of the manipulated variable in each control cycle T_{c}, calculates an estimated value Best of the model parameter of the plant response function {S_{θ}(t)}, and outputs the estimated value Best. The model parameter estimating unit 106 need only calculate the estimated value Best of the model parameter by a known method, such as a recursive least squares method (for example, a method described in Patent Document 4 or the like). The estimated value θ=θₑₛₜ of the model parameter is set to the plant response function {S_{θ}(t)}. Here, when the estimated value θₑₛₜ of the model parameter is calculated, an initial value θ₀ of the model parameter may be input.

Here, as an example of the model parameter θ, a case where an autoregressive moving average model (ARMA model) is used as the plant response function {S_{θ}(t)} will be described. For example, an ARMA model using autoregression of past N points as the controlled variable y and a moving average of a current value and past M points as the manipulated variable u is expressed as follows.

Y(k)=a₁y (k−1)+a₂y (k−2)+ . . . +a_{N}y(k−N)+b₀u (k)+b₁u(k−1)+b₂u(k−2)+ . . . +b_{M}u(k−M). Here, N and M are preset integers of 1 or greater.

At this time, the model parameter θ is expressed as follows.

$$θ = [ \begin{matrix}{a}_{1} \\ {a}_{2} \\ ⋮ \\ {a}_{N} \\ {b}_{0} \\ {b}_{1} \\ {b}_{2} \\ ⋮ \\ {b}_{M}\end{matrix} ] \qquad [ Equation 4 ]$$

That is, elements of the model parameter θ are coefficients of the ARMA model. Here, k is an index and is an integer starting from k=1.

Here, the ARMA model described above is an example, and may be a model in consideration of disturbance v at past L points (L is a preset integer of 1 or greater). Additionally, the embodiment is not limited to the ARMA model, and for example, an autoregressive moving average model with exogenous variables (ARMAX) model or the like may be used as the plant response function {S_{θ}(t)}.

The timer 104 causes the obtaining unit 101, the manipulated variable updating unit 103, and the model parameter estimating unit 106 to operate in each control cycle T_{c}. That is, the timer 104 further operates as an operation trigger of the model parameter estimating unit 106 in each control cycle T_{c}.

With the functional configuration described above, the control device 10 according to the present embodiment can control the control target plant 20 by sequentially repeating the obtaining of the controlled variable y and the manipulated variable u by the obtaining unit 101, the estimating of the model parameter θ=θₑₛₜ by the model parameter estimating unit 106, and the calculating of the new value of the manipulated variable u by the manipulated variable updating unit 103 in each control cycle T_{c}.

### Example 1

In the following, Example 1 of the control device 10 according to the second embodiment will be described. In this example, the effectiveness of the control device 10 according to the second embodiment is described when there is an error between the control target plant 20 and the plant response model.

In this example, it is assumed that the plant response model of the control target plant 20 is represented by the following ARMA model.

$$y ( k ) = {θ}_{1} y ( k - 1 ) + {θ}_{2} y ( k - 2 ) + {θ}_{3} u ( k ) + {θ}_{4} u ( k - 1 ) + {θ}_{5} u ( k - 2 )$$

The state vector is defined below.

$$φ ( k ) = [ \begin{matrix}y ( k - 1 ) \\ y ( k - 2 ) \\ u ( k ) \\ u ( k - 1 ) \\ u ( k - 2 )\end{matrix} ] \qquad [ Equation 5 ]$$

The model parameter θ is defined as follows.

$$θ ( k ) = [ \begin{matrix}{θ}_{1} ( k ) \\ {θ}_{2} ( k ) \\ {θ}_{3} ( k ) \\ {θ}_{4} ( k ) \\ {θ}_{5} ( k )\end{matrix} ] \qquad [ Equation 6 ]$$

When the estimated value of the controlled variable by the plant response model is represented by yₑₛₜ, the estimated value of the controlled variable is calculated by yₑₛₜ(k)=φ(k)^{T}θ(k−1). T represents transposition.

Here, in the case of using the control device 10 according to the first embodiment, it is only necessary to set the model parameter θ to a fixed value that does not change over time. That is, the model parameter θ (k) need be only independent of the index k, that is, θ(k)=0.

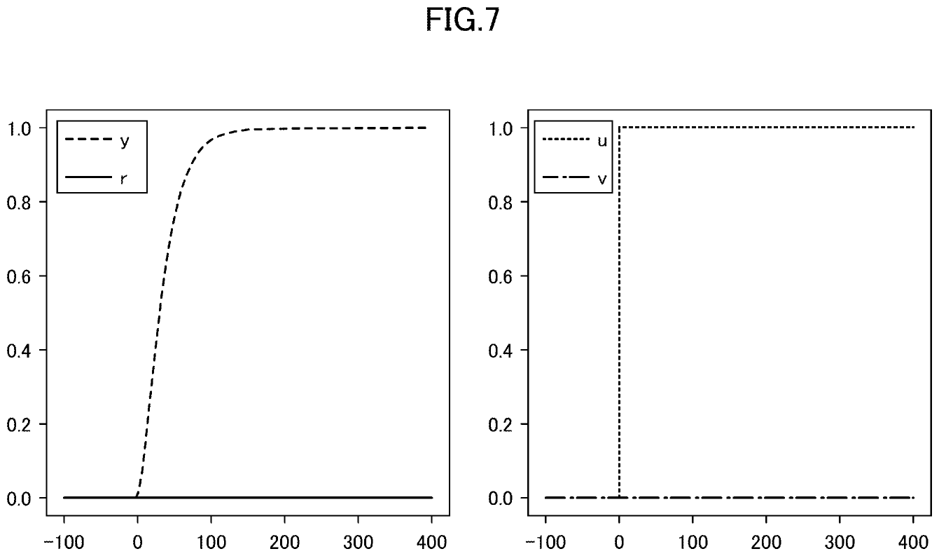

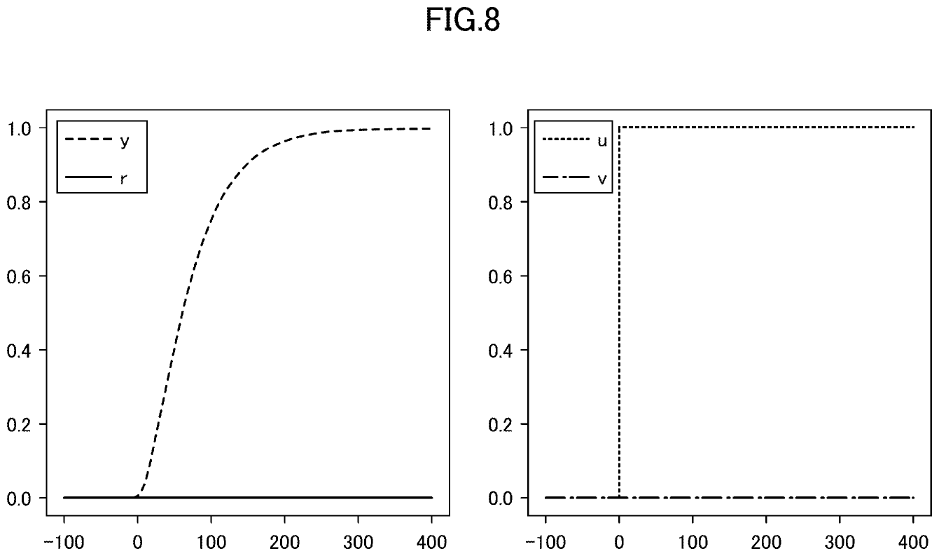

FIG. 7 indicates the step response of the control target plant 20 in this example. FIG. 8 indicates the step response of the plant response model in this example. FIG. 7 and FIG. 8 both indicate changes in the controlled variable y when the manipulated variable u changes in a unit step manner at time 0. As illustrated in FIG. 7 and FIG. 8, the time constant of the plant response model is longer than that of the control target plant 20, and it can be said that error (model error) is present in the plant response model.

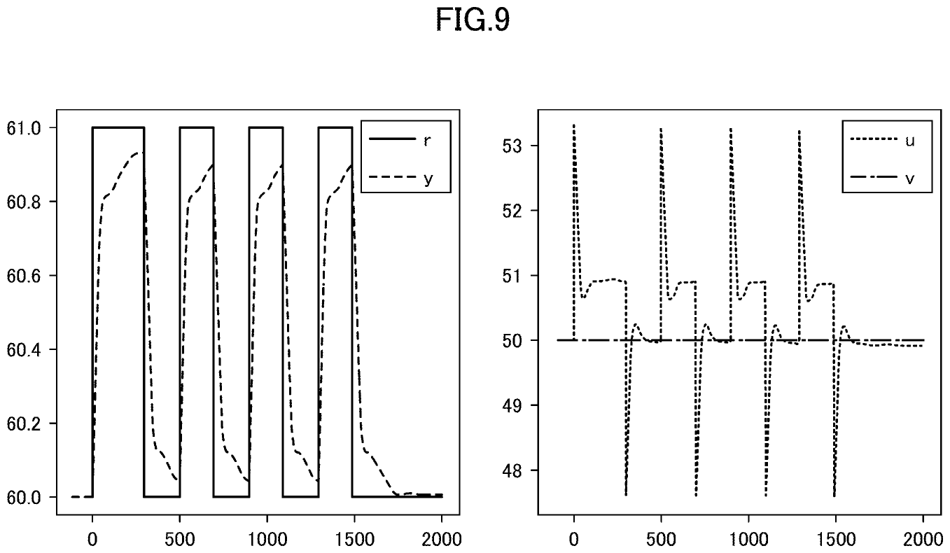

FIG. 9 indicates the control response of the plant response model in a case where the forgetting is not performed (that is, in a case where λ=1). As indicated in FIG. 9, the tracking of the controlled variable y to the target value r is delayed due to the influence of the model error.

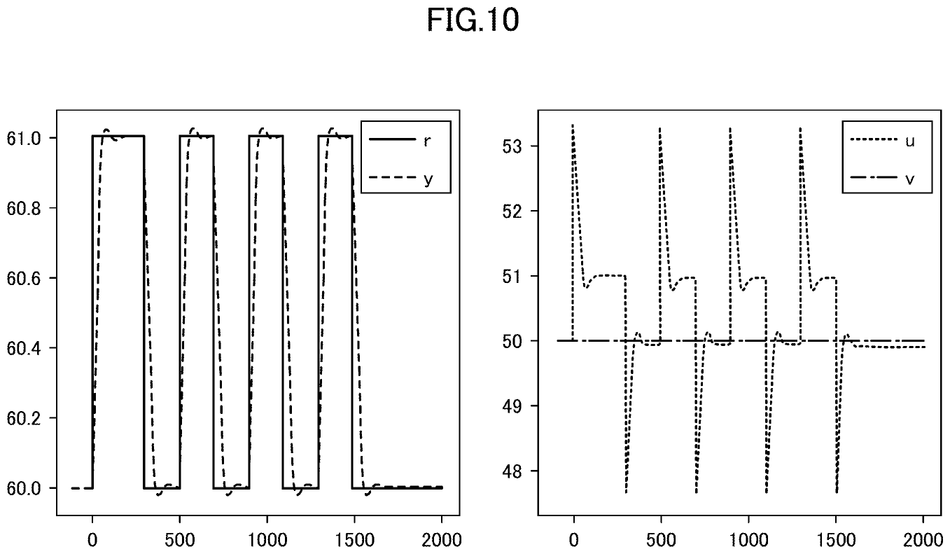

FIG. 10 indicates the control response of the plant response model in a case where the forgetting is performed (in this example, λ=0.99). As indicated in FIG. 10, the performance of the tracking of the controlled variable y to the target value r is improved in comparison with FIG. 9. Therefore, in the control device 10 according to the second embodiment (or the control device 10 according to the first embodiment when the model parameter θ is a fixed value without changing over time), it can be said that the effect of the prediction time series data in consideration of the forgetting can suppress an adverse effect on the control due to the prediction error caused by the model error.

### Example 2

In the following, Example 2 of the control device 10 according to the second embodiment will be described. In this example, the effectiveness of the control device 10 according to the second embodiment is described in a case where an unknown disturbance is applied to the control target plant 20. Here, except for being particularly mentioned, the setting is substantially the same as that of Example 1.

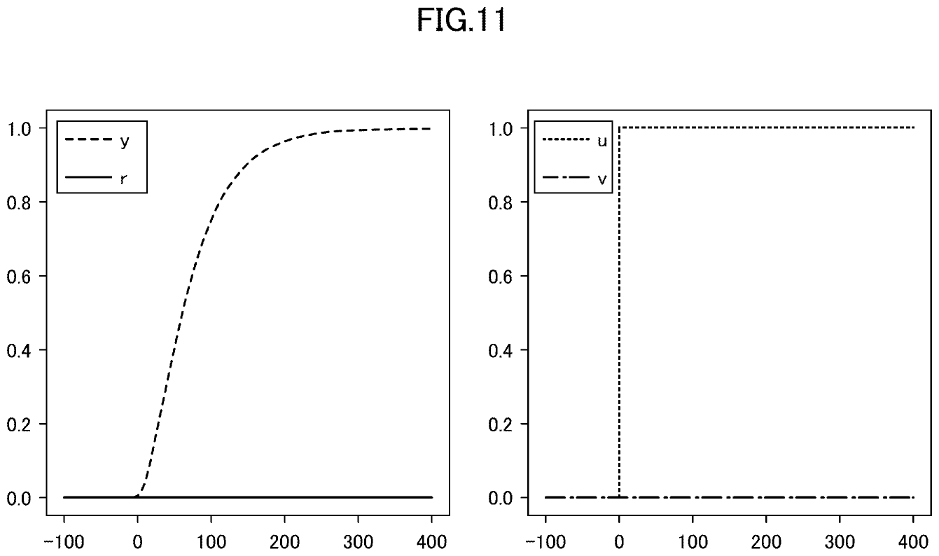

FIG. 11 indicates the step response of the control target plant 20 and the plant response model in this example. FIG. 11 indicates a change in the controlled variable y when the manipulated variable u changes in a unit step manner at the time 0. In this example, it is assumed that the control target plant 20 and the plant response model match with each other.

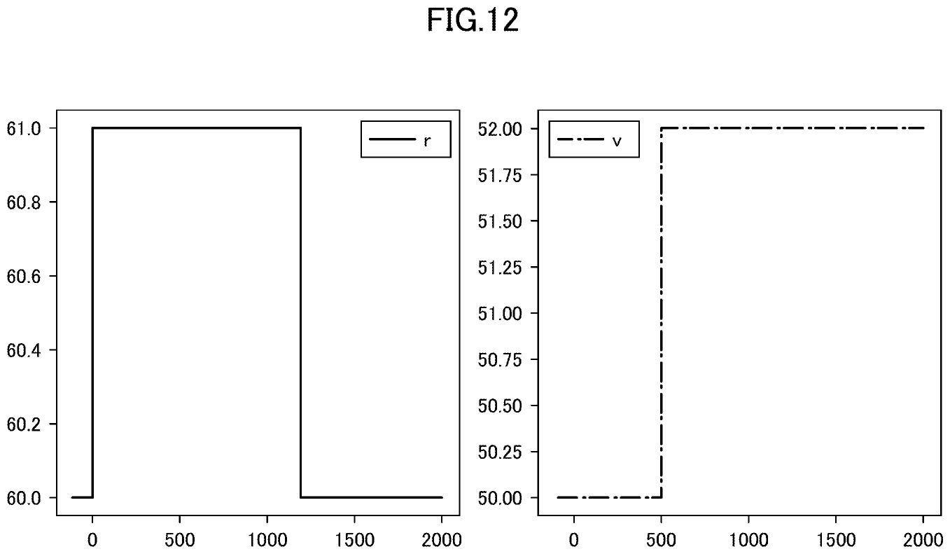

FIG. 12 indicates the target value r and the disturbance v in this example. As illustrated in FIG. 12, in this example, it is assumed that the unknown disturbance v is applied in a step at the time 500.

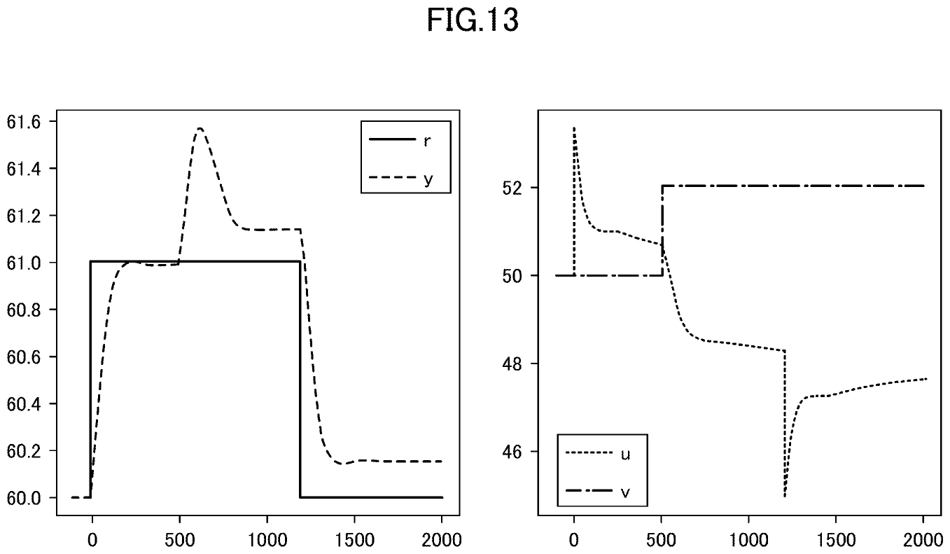

FIG. 13 indicates the control response of the plant response model in the case where the forgetting is not performed (that is, in the case where λ=1). As illustrated in FIG. 13, the influence of the unknown disturbance v causes a difference between the controlled variable y and the target value r after the time 500, and the offset continues until the time 2000.

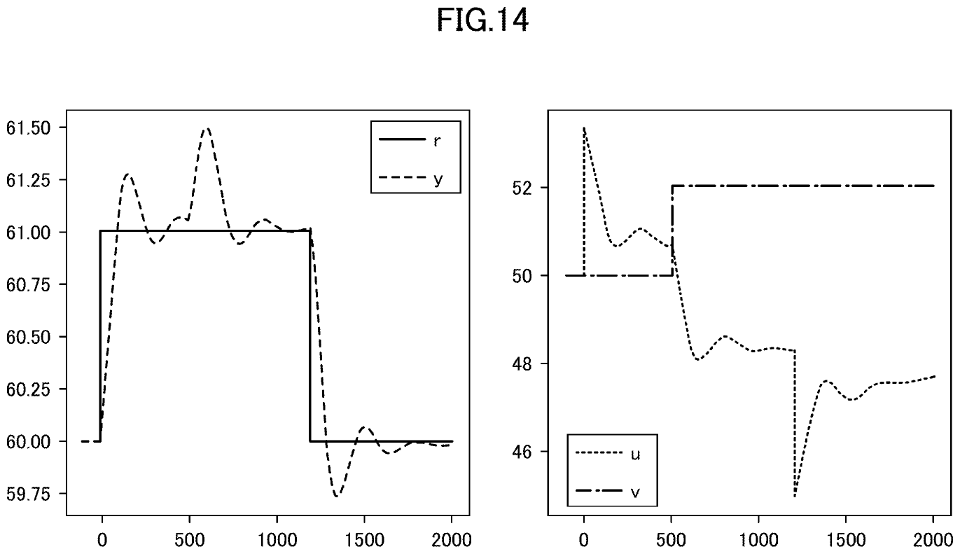

FIG. 14 indicates the control response of the plant response model in the case where the forgetting is performed (in this example, λ=0.99). As illustrated in FIG. 14, the performance of the tracking of the controlled variable y to the target value r is improved in comparison with FIG. 13. Therefore, in the control device 10 according to the second embodiment (or the control device 10 according to the first embodiment when the model parameter θ is a fixed value without changing over time), it can be said that the effect of the prediction time series data in consideration of the forgetting can suppress an adverse effect on the control due to the prediction error caused by the unknown disturbance.

According to Example 1 and Example 2, the control device 10 according to the second embodiment (or the control device 10 according to the first embodiment when the model parameter θ is a fixed value without changing over time) can suppress an adverse effect of the error of the future prediction in the model predictive control, and as a result, can suppress the deterioration of the control performance.

### SUMMARY

As described above, the control device 10 according to the first embodiment asymptotically forgets the prediction made in the past, thereby suppressing an adverse effect on the control due to the prediction error of the model predictive control. Additionally, at this time, the update of the forgetting prediction time series storage unit 105 can be performed at high speed, thereby suppressing an adverse effect on control due to the prediction error of the model predictive control without reducing responsiveness. Furthermore, because a value of the forgetting factor can be set as appropriate, the user or the like can adjust the strength of the forgetting. In addition, the present embodiments can effectively cope with the case where the target deviation has an offset during control.

The control device 10 according to the second embodiment sequentially estimates (learns) the model parameter θ in addition to the matters described in the first embodiment. Therefore, for example, in the case where the model parameter θ itself changes over time, the past prediction with insufficient learning can be actively forgotten, thereby suppressing an adverse effect that is likely to cause the prediction error.

The present invention is not limited to the above-described embodiments specifically disclosed, and various modifications, changes, combinations with known techniques, and the like can be made without departing from the description of the claims.

What is claimed is:

1. A control device comprising:
a processor; and
a memory storing program instructions that cause the processor to:
calculate a target deviation that is a difference between a target value and a current value of a controlled variable for a control target at a current time;
store forgetting prediction time series data including predicted values obtained by forgetting a predicted value of the controlled variable that is predicted in a past time by a plant response function representing a plant response model of the control target;
calculate a corrected target deviation from the target deviation and a predicted value of the controlled variable after a predetermined lookahead length elapses, based on the forgetting prediction time series data;
calculate a change in a value of a manipulated variable based on the corrected target deviation and a predetermined control gain;
calculate a new value of the manipulated variable by adding the change of the value of the manipulated variable to the value of the manipulated variable; and
output the new value of the manipulated variable to the control target so that a value of the controlled variable of the control target is caused to track the target value.

2. The control device as claimed in claim 1, wherein each of the predicted values included in the forgetting prediction time series data is represented by a sum of a product of the change in the value of the manipulated variable at the current time and the predicted value of the controlled variable by the plant response function; and a value obtained by forgetting, by a predetermined forgetting factor, among the predicted values included in the forgetting prediction time series data at a time one time interval before the current time, a predicted value at a time corresponding to a time of the predicted value of the controlled variable by the plant response function.

3. The control device as claimed in claim 2, wherein each of the predicted values y_{n,c}(t+mΔt|t) included in the forgetting prediction time series data is represented by the sum of the product S(mΔt) du(t) of the change du(t) of the manipulated variable at the current time and the predicted value S(mΔt) of the controlled variable by the plant response function, and λ·y_{n,c}(t+mΔt|t−Δt), when t is the current time, t−Δt is the time one period before the current time, S (·) is the plant response function, λ is the forgetting factor, and m is an integer of 0 or greater.

4. The control device as claimed in claim 3, wherein the forgetting factor λ is a real number satisfying 0≤λ≤1.

5. The control device as claimed in claim 1, wherein the program instructions further cause the processor to sequentially estimate a model parameter of the plant response function based on the controlled variable and the manipulated variable.

6. A control method comprising:
calculating a target deviation that is a difference between a target value and a current value of a controlled variable for a control target at a current time;
storing forgetting prediction time series data including predicted values obtained by forgetting a predicted value of the controlled variable that is predicted in a past time by a plant response function representing a plant response model of the control target;
calculating a corrected target deviation from the target deviation and a predicted value of the controlled variable after a predetermined lookahead length elapses, based on the forgetting prediction time series data;
calculating a change in a value of a manipulated variable based on the corrected target deviation and a predetermined control gain;
calculating a new value of the manipulated variable by adding the change of the value of the manipulated variable to the value of the manipulated variable; and
outputting the new value of the manipulated variable to the control target so that a value of the controlled variable of the control target is caused to track the target value.

7. A non-transitory computer-readable recording medium having stored therein a program causing a control device to perform a process comprising:
calculating a target deviation that is a difference between a target value and a current value of a controlled variable for a control target at a current time;
storing forgetting prediction time series data including predicted values obtained by forgetting a predicted value of the controlled variable that is predicted in a past time by a plant response function representing a plant response model of the control target;
calculating a corrected target deviation from the target deviation and a predicted value of the controlled variable after a predetermined lookahead length elapses, based on the forgetting prediction time series data;
calculating a change in a value of a manipulated variable based on the corrected target deviation and a predetermined control gain;
calculating a new value of the manipulated variable by adding the change of the value of the manipulated variable to the value of the manipulated variable; and
outputting the new value of the manipulated variable to the control target so that a value of the controlled variable of the control target is caused to track the target value.
